(19) United States
(12) Patent Application Publication
(10) Pub. No.: US 2013/0080894 A1
(43) Pub. Date: Mar. 28, 2013

(54) DISPLAY DEVICE AND SYSTEM AND METHOD INCORPORATING SUCH DEVICE

(71) Applicants: Cyril Renard, Reading (GB); Fabrice Beaugrand, Reading (GB); Frederic Fok, Reading (GB)

(72) Inventors: Cyril Renard, Reading (GB); Fabrice Beaugrand, Reading (GB); Frederic Fok, Reading (GB)

(73) Assignee: NEC CORPORATION, Tokyo (JP)

(21) Appl. No.: 13/637,575

(22) PCT Filed: Mar. 28, 2011
(86) PCT No.: PCT/JP2011/058469

§ 371 Date: Dec. 5, 2012

(30) Foreign Application Priority Data
Mar. 26, 2010 (GB) 1005128.2

(51) Int. Cl. G06F 3/0484

(52) U.S. Cl. CPC G06F 3/0484; H04L 67/06
USPC 715/716

(57) ABSTRACT

The invention provides for a method and related system of displaying to a user at a user display device content delivered wirelessly from a remote server, and of displaying to the user content from a mobile radio communications device, the method comprising the steps of routing the content from the remote server to the user display device via the mobile radio communications device, and delivering content from the mobile radio communications device to the user display device for display thereon, and in this manner a user device such as a mobile phone can have the subject of its display delivered to a remote display device for display in combination with, for example, a PC application running as a remote server, and further wherein the user interface devices associated with the display device can be employed to interact with the remote server and the mobile radio communications device.

### PRIORITY CLAIM

Priority is claimed on United Kingdom Patent Application No. 1005128.2, filed Mar. 26, 2010, the content of which is incorporated herein by reference.

### TECHNICAL FIELD

The present invention relates to a system for communicating data/content to a plurality of display devices, and to such display devices per se and also to a method of providing the required display of the data/content.

### BACKGROUND ART

When required, data/content is commonly presented to a user by way of an electronic display device and due to the wide variety of media available, a user will quite often have access to a plurality of display devices, each arranged to display specific content often relating two different applications with which the user has an interest in interacting. Each of the plurality of display devices is therefore commonly associated with some form of user-interface means, generally a touch-screen, mouse, track ball and/or keyboard/pad such that when a user desires to interact with the content of one of the display devices, it is necessary to access the respective interface device.

The need to alternate between the different interface devices can prove disadvantageously inconvenient and can represent a potentially inefficient use of the user's time and of the various resources available particularly in view of the delay that might be experienced in overcoming, even temporary, security measures related to use of the interface means.

In particular, with the widespread adoption of personal mobile radio communication devices such as mobile phone or personal digital assistant, one such display device that is commonly located in proximity to the user is such a mobile device. Should such a user be interacting with, for example, a PC device by way of the PC's screen, the user is then presented with two quite separate devices, each requiring the user's attention, and accessed by way of their respective interface arrangements.

Also, with the advent of so called “thin client” architectures, a user will commonly interact with content displayed on a local user display device which is effectively being driven by a connection to a remote server device.

The user display device of such a thin client arrangement, and a user's mobile radio communications device, can therefore represent examples of the above mentioned plurality of display devices which, at present, exhibit limitations and inefficiencies when accessed by the user.

### DISCLOSURE OF INVENTION

The present invention therefore seeks to provide for a method and related system for the display of content of a plurality of devices, and to such devices per se, and having advantages over known such systems, methods and devices.

While various split-screen video systems are known from, for example, CN-A-101557496, US-A-2007250867 and KR-A-20040089313, none of these arrangements relate to, or in anyway address, the above mentioned problems exhibited in the current art when a user is interfacing with two separate devices. Also, standard thin client arrangements are also known from KR-A-2002 0077787 and KR-A-20020067746 but again, neither of these documents addresses the problem faced and overcome by the present invention.

As a further aspect, the present invention seeks to provide for an improved system and related method and devices in which such devices are arranged to display content wirelessly.

According to a first aspect of the present invention there is provided a method of displaying to a user at a user display device content delivered from a remote server, and of displaying to the user content from a mobile radio communications device, the method comprising the steps of routing the content from the remote server to the user display device via the mobile radio communications device, and delivering content from the mobile radio communications device to the user display device for display thereon.

In this manner, the present invention can advantageously reduce the number of display devices with which the user must interact to a single device irrespective of the number of devices, and related applications, with which the user desires to interact.

The present invention therefore represents a far more convenient and efficient arrangement by which the user can interact with a plurality of display devices.

In one arrangement, the step of delivering the content from the mobile radio communications device to the user's display device can comprise a selectively initiated step.

Advantageously, the initiation of that step can be responsive to the handling of an application within the mobile radio communications device. For example, the delivery of the content from a mobile radio communications device can be responsive to an incoming signal arriving at the mobile radio communications device and/or the user's response to the arrival of that signal.

Further, the display of content delivered from the remote server can occur simultaneously with the display of content from the mobile radio communications device.

Also, within all aspects of the present invention, content from the mobile radio communications device can comprise data emulating features of the mobile radio application device, such as for example the keypad, trackball etc.

In one arrangement, the simultaneous display can arise from the combination of the content from a remote server and the content from the mobile radio communications device locally at the mobile radio communications device.

In an additional or alternative arrangement, combination of the content from the remote server device and the content from the mobile radio communications device can be completed at the remote server.

According to a particularly advantageous further feature, the method includes a step of interfacing with the mobile radio communications device by way of user interface means associated with the user display device. Such interfacing can be achieved by way of any appropriate means such as a keyboard and/or mouse etc.

Advantageously therefore, control signaling arising from the user interface device associated with the user display device is delivered to the mobile radio communications device.

Yet further, control signaling from the user interface device associated with the user display device can be delivered to the remote server via the mobile radio communications device.

At the mobile radio communications device, the control signaling arriving from the user interface device associated with the user display device can be selectively employed to interface with the mobile radio communications device and/or the remote server.

In this manner, and in addition to only requiring a single display device for the display of content originating from the remote server and from the mobile radio communications device, the user also only requires a single interface arrangement, such as the user interface device associated with the user display device, in order to interact with the remote server and the mobile radio communications device and, in particular, to interact with the content from the server and the mobile radio communications device as displayed on the user display device.

According to another aspect of the present invention there is provided a mobile radio communications device arranged to display content according to an application therein, and to receive content from a remote server and to deliver the content from the remote server to a user display device remote from the radio communication device and to further deliver the content derived from the application to the user display device for display thereon.

Advantageously, the delivery of content relating to the application on the mobile radio communications device can be selective and/or responsive to the application.

According to a further feature, the mobile radio communications device is arranged to receive control signaling from a user interface device associated with the user display device and to deliver such control signaling to the remote server and/or to allow for control of the application in accordance with said control signaling.

Again, the control of the application by way of the control signaling can be achieved in a selective and/or responsive manner.

According to yet another aspect of the present invention, there is provided a communications system including a user display device, a server remote from the user display device and for delivering content to the user display device, and a mobile radio communications device for access by the user, the system being arranged to route content from the server to the user display device via the mobile radio communications device, and to display content from the mobile radio communications device at the user display device.

Of course, the wireless communication system defined above can include a mobile radio communications device such as that also defined above.

According to another aspect of the present invention, there is provided a method of controlling the display of content relating to an application of a mobile radio communications device and including the step of delivering the content to a remote user display device, which is also arranged for displaying content delivered wirelessly from a remote server and via the mobile radio communication device.

The invention can also provide for a computer program, computer program product and computer-readable medium including instructions for carrying out the steps of one or more of the methods defined above.

As it should also be appreciated, the content can be delivered to the user display device either wirelessly, or in a wide manner such as, for example, by way of an Asynchronous Digital Subscriber Line.

As will be appreciated, by means of the present invention, greater efficiencies can be achieved for a user seeking to interact with a plurality of devices and, in particular, improved “user experience” can be achieved by, for example, rendering mobile applications onto a remote desktop application and onto a common user display device generally associated with the remote desktop.

### BRIEF DESCRIPTION OF THE DRAWINGS

The invention is described further hereinafter, by way of example only, with reference to the accompanying drawings in which:

FIG. 1 is a schematic illustration of a current multi-device system arrangement as requiring interaction by a user;

FIG. 2 is a similar schematic arrangement but illustrating an embodiment of a system according to an embodiment of the present invention;

FIG. 3 is a further summarizing schematic illustration of a system embodying the present invention;

FIG. 4 is a block schematic diagram of system elements such as those employed according to embodiments for the present invention;

FIG. 5 is a operational flow diagram illustrating a method according to one embodiment of the present invention; and

FIG. 6 is a further operational flow diagram illustrating a method according to yet another embodiment of the present invention.

### EMBODIMENTS FOR CARRYING OUT THE INVENTION

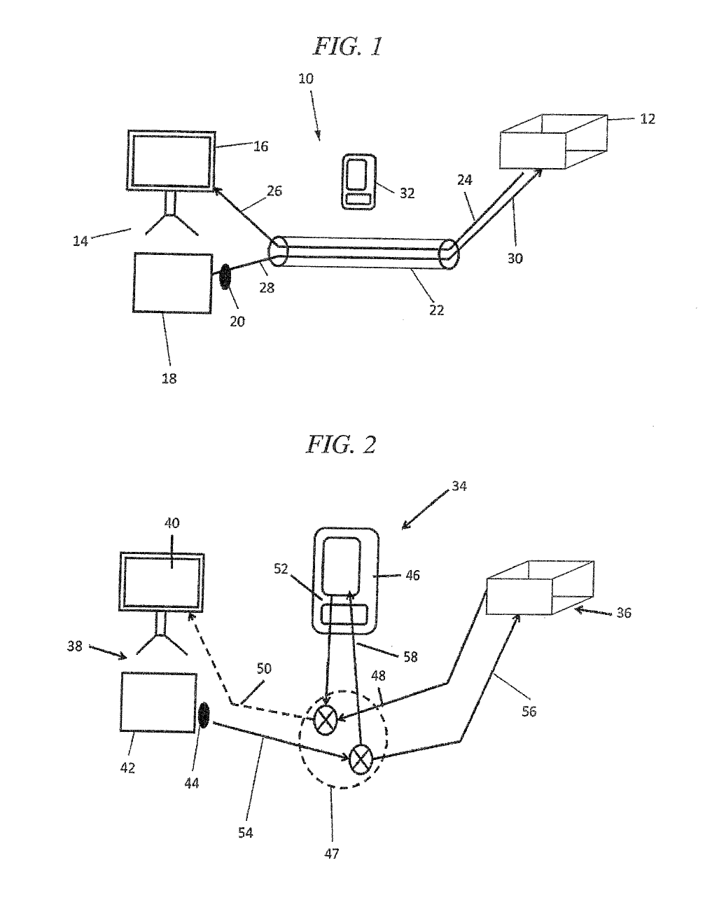

Turning first to FIG. 1, there is provided a schematic illustration of a system as currently found in the art and to which the present invention, in one particular embodiment, relates.

A multi display-device system 10 employs a “thin client” architecture including a remote server arrangement 12, for example, presenting a virtual PC, and local user devices 14 comprising a user display 16, user keyboard 18 and user mouse 20.

The thin client architecture allows for all of the necessary processing and content generation to be conducted at the remote server 12 even though the user interfaces with the “client” arrangement 14 locally by way of the screen 16, keyboard 18 and mouse 20.

An appropriate communications link 22 receives, for example, a virtual PC rendering data flow 24 from the remote server 12 and delivers it 26 to the user display device 16 for display thereon.

In order to interact with the displayed content of the screen 16, Human Interface Device (HID) events are delivered at 28 from the keyboard 18 and/or mouse 20 to the communications link 22 and onwards at 30 to the remote server arrangement 12 so that, for example, the user can interact with an application running on a remote server 12. In turn, the user can influence the rendered data 24, 26 displayed on the screen 16 whilst, for example, running the required application.

The user accessing the keyboard 18 and mouse 20 will commonly also be in possession of a further device to which, or from which, data can be communicated and which also presents at least one of the plurality of screen and/or user interface arrangements and such as a mobile device 32 illustrated in FIG. 1.

Thus, within the scenario illustrated in FIG. 1, a user can, for example, run some PC applications using the external screen 16 of the thin client arrangement. However, at the same time, it can be necessary to run, for example, a mobile device application by way of the internal screen of the mobile device 32 and the keyboard and, for example, the keyboard/trackball thereof.

To achieve such a dual operation, the user has to interface separately with either the remote screens/keyboard/mouse combination 16, 18 and 20, or with the mobile device 32.

Such an arrangement can prove disadvantageously cumbersome insofar as the user has to interface with a plurality of screens and, for example, keyboards, etc.

Turning now to FIG. 2, there is provided a summarizing schematic illustration of an embodiment of the present invention and which serves to overcome disadvantages such as those discussed above in relation to FIG. 1.

In this illustrated embodiment of the present invention, there is again provided a multi-device system 34 employing a remote server 36 as part of a thin client architecture presenting a local user interface arrangement 38 comprising a screen 40, keyboard 42 and mouse 44. The illustrated scenario again employs a mobile device 46 as one of the plurality of display devices and, importantly, the mobile device 46 includes functionality47 allowing it to serve as a node for the communication of content/data between the remote server 36 and the user interface arrangement 38.

The communication link between the remote server 36 and the user interface arrangement 38 of the thin client architecture therefore comprises a wireless link and the functionality of the node 47 of the mobile device 46 is to receive a rendering data flow 48 from the remote server 36 and to deliver the same 50 to the user display screen 40. In addition, there is a requirement to include a mobile rendering data flow 52 relating to data to be displayed by way of the internal screen of the mobile device 46 such that the user display screen 40 can present a simultaneous display of both the rendering data flow originating from the remote server 36 and the mobile application rendering data flow originating from the mobile device 46.

As will be appreciated from the related discussion herein, the addition of the mobile application rendering data flow 52 can be achieved in a selective manner and such selectivity can be controlled in response to ongoing operational characteristics of the mobile device 46, such as the start of a mobile application triggered by an incoming signal.

For example, should it be identified that the mobile device 46 receives an incoming call such as a voice call or text message etc., the addition of the mobile application rendering data flow 52 to that 48 arriving from the remote server 36 can be initiated upon arrival of that call or upon the user of the mobile device 46 accepting that call.

Insofar as the invention can advantageously allow for the combined display of the rendering data flow from the remote server 36 and the mobile application rendering data flow from the mobile device 46 onto a common user display screen 40, the invention can also advantageously allow for the applications running on both the remote server 36 and the mobile device 46 to be controlled by way of a common interface arrangement comprising the keyboard 42 and mouse 44.

As illustrated in FIG. 2, HID events 54 are therefore delivered from the keyboard/mouse combination 42, 44 and are arranged to be routed within the functional node 47 of the mobile device 46 to the appropriate target device either as HID event 56 delivered to the remote server 36, or HID event 58 delivered to the mobile device 46.

The user can then easily and efficiently interact with either the remote server application or the mobile device application by means of keyboard/mouse combination 42, 44 and the combined content illustrated on the user display screen 40.

As with the potential simultaneous display of the rendering data flow from the remote server 36, and the mobile application rendering data flow from mobile device 46, the HID events 54 from the keyboard/mouse combination 42, 44 can be delivered to the appropriate target device in a selective and/or responsive manner.

As will therefore be appreciated from the forgoing, while the user is, for example, editing a PC file in accordance with the thin architecture 36, 38, should an incoming mobile phone call arrive, the user can interact with the mobile device 36 simply by way of the keyboard/mouse combination 42, 44 and the user display screen 40. There is then no actual need to divert attention away from that interface arrangement 38 in order to handle the application, which in this example comprises an incoming phone call, arising at the mobile device 46.

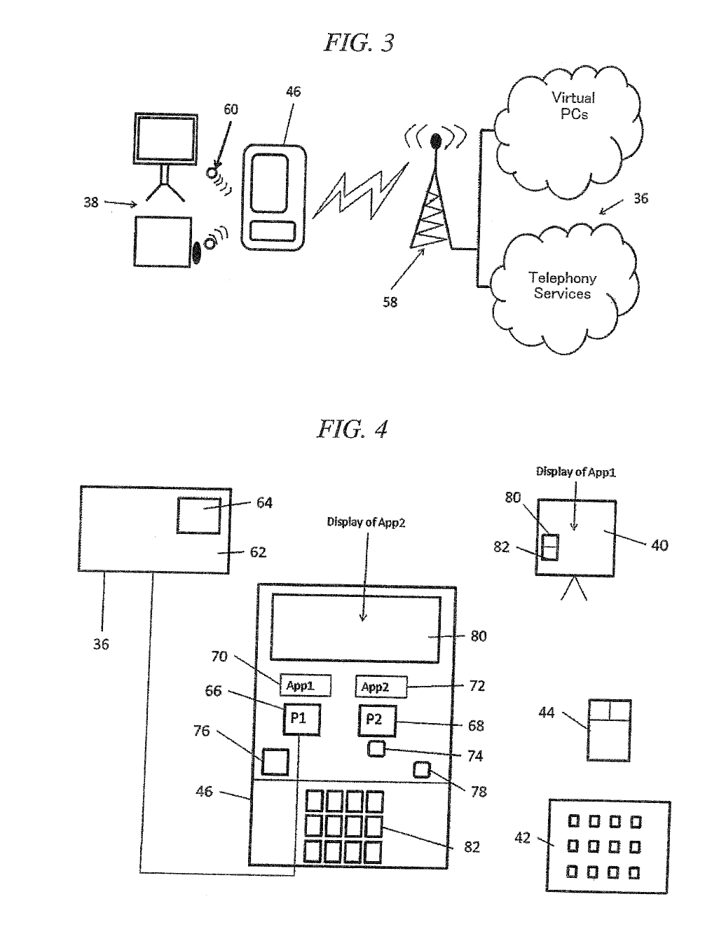

FIG. 3 provides a further schematic illustration of such a system embodying the present invention and illustrating the wireless connectivity between the mobile device 46 and the remote server 36 which, in the restricted example, is by way of a base station 58, and the, generally more local, wireless communication 60 with the user interface arrangement 38 comprising the user display, keyboard and mouse devices.

Into such an arrangement, it should be appreciated that the mobile device 46 generally presents an internal screen, whereas the interface arrangement 38 comprises an external screen and external HIDs.

As confirmed in this further illustration, the mobile device 46 is arranged to receive both standard network communication signaling from the base station 58 and also, for example, rendering data relevant to the remote application running on the remote server 36 and intended for the user display screen of the user interface arrangement 38.

Thus, content relating to an application running locally on the mobile device can be incrusted onto the rendering data of the remote PC application from the remote server so as to present it to the external screen of the thin client arrangement, rather than, or in addition to the internal screen of the mobile device.

As discussed further below in greater detail, the invention can advantageously provide for the incrusting of both the mobile application rendering and also mobile-hardware emulation rendering within the remote PC application rendering data so as to provide a combined display, at a common user display device. Such combined display comprises both the rendering relevant to the remote PC application, rendering relevant to the actual mobile application and, indeed, rendering relevant to an emulation of the mobile hardware device such that an image corresponding to the actual device can appear on the common display screen in addition to the rendered mobile application data.

Advantageously the mobile-hardware emulation allows the user to interact with the mobile phone application using emulated buttons (e.g. a pressing a phone call button or a search button, etc.).

Further aspects of the present invention are now discussed in greater detail in relation to FIG. 4 which comprises a schematic diagram of the various system elements such as those illustrated in FIGS. 2 and 3 of the present application.

Within FIG. 4, there is illustrated a remote server 36, user display screen 40, user keyboard 42, user mouse 44 and user mobile device 46 such as illustrated for example in FIG. 3.

Turning first to the remote server 36 as noted, this can comprise a thin client server 62 running, for example, a PC application 64.

With regard to the mobile device 46, there is provided a first module 66 for generating rendering data relevant to a first application and a second module 68 generating rendering according to the second application. The first application can comprise, for example, a PC application 70 generated either locally or remotely through the thin client technology, and the second application 72 can comprise a mobile application arising locally within the mobile device 46.

A module 74 is provided for combining the rendering of mobile application 72 with the rendering relating to emulated peripherals, for example (keypad and trackball) of the mobile device 46, and a further module 76 is provided for combining rendering of application 70 with the output of the combined rendering arising in module 74.

A decision module 78 is further provided and which is arranged to detect a particular application event. This provides means by which, for example, the combined rendering provided by module 76 can be completed in a manner responsive to the particular application event which, for example, could comprise the arrival of an incoming call or, indeed, the users response to the arrival of such a call.

For illustrative purposes, reference is also made to the internal screen 80 and keyboard 82 of the mobile device 46 since, in view of the combination of the rendering achieved by way of module 74, an image of the exterior of the local mobile device 46 comprising screen 80, and of course data to be displayed thereon, and the keypad 82, can be combined with the rendering application 70 within the module 76 so as to be displayed on the user display screen 40 as illustrated within FIG. 4.

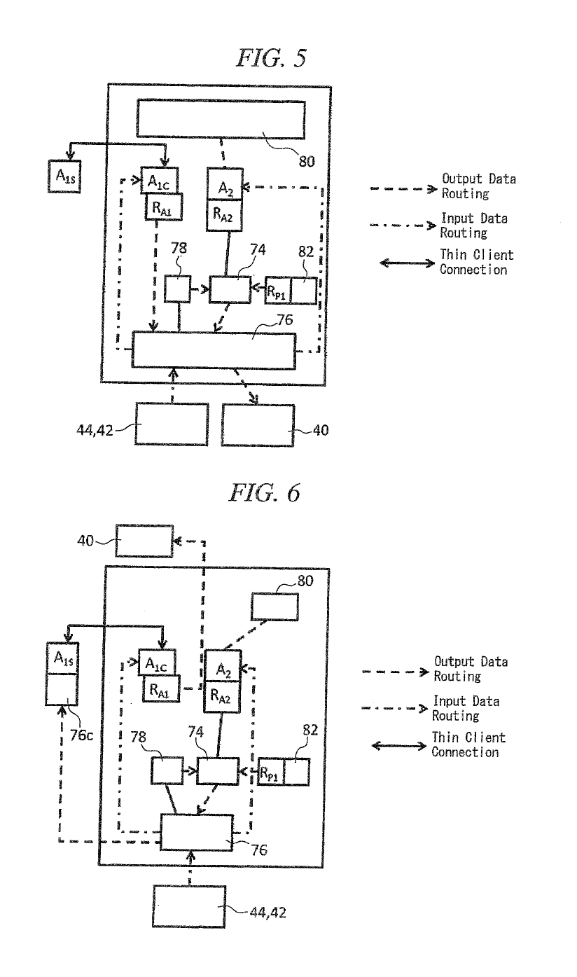

Reference is now made to FIGS. 5 and 6 of the present application which, in addition to the illustration of FIG. 4, provides further illustration of two scenarios of an embodiment illustrating the present invention.

Turning first to FIG. 5, there is illustrated a flow diagram chart of an example of the present invention in which output is to be generated locally within the mobile device such as the device 46 illustrated previously.

As illustrated with reference to FIG. 4, such a mobile device 46 can be connected with a thin client server and within the following discussion, and with reference to FIGS. 5 and 6, it should be appreciated that any rendering data (e.g. image, video) arising in the mobile device is referred to as “output data”, and any required user input such as key/mouse events serves to generate so called “input data”.

Also, in both of FIGS. 5 and 6, there are provided schematic illustrations of the user display device 40, user keyboard and mouse 42, 44, the mobile device internal display 80 and the keypad 82 of the mobile device.

Also illustrated are the above mentioned modules, 74, 76 and 78.

The flow chart commences with reference to module 74 which, under the control of the decision module 78, serves to initiate the required combination of the relevant rendering data and, in this manner, provides a combination of the rendering R_{PI} of the mobile device peripherals such as the keypad 82, and the rendering R_{A2} of the second application 72 of FIG. 4 and comprising the mobile application originating within the mobile device 46 and to be displayed on the display 80. The output of such combination of the rendering at the module 74, as noted above, is input to the further module 76 which is also arranged to receive the rendering R_{AI} of the first application 70 which can be derived by way of the thin client connection illustrated from a server side connection A_{IS}.

Such further combined rendering arising within the module 76 again in the output as indicated to the user display screen 40.

As should be appreciated, both the modules 74, 76, in seeking to combine the rendering data can employ, as an example, alpha blending operating with, for example, any appropriate transparency value for the rendering R_{A2} of the second application 72.

Of course, various other imaging arrangements can be employed such as alternative overlay layers.

As also illustrated in FIG. 5, due to the connectivity between the user keyboard/mouse 42, 44 combination with the module 76, the input arising from these peripheral devices 42, 44 can be directed by means of the module 76 as indicated to either the client side A_{1C} of the first application, or the mobile application A₂.

Thus, depending on which of the applications is, and at the time, to be controlled by way of the keyboard 42 and mouse 44 peripheral devices the target application for such embodiment can be varied as required.

Turning now to FIG. 6, there is illustrated a similar flow chart to that of FIG. 5 but wherein for this scenario there is at least in part a remote aspect to the generation of the combined rendered data to the output to the user display 40.

Similar initial steps are taken to those noted above and module 74 serves to combine the rendering data R_{PI} of the mobile device keypad 82 with the rendering data R_{A2} of the mobile application, i.e. the second application 72 of FIG. 4 which is then delivered to the module 76 which, in this example, comprises a server-side module 76s.

The combined rendered data arriving at server-side module 76 is delivered to the remote location comprising client-side module 76c for remote combination with the server-side first application data A_{IS} which, then by way of the rendering data R_{AI} at the client-side of the first application A_{1C} is to look as those indicated to the user display 40.

Again, the use of peripheral devices comprising the keyboard 42 and mouse 44 can be employed to interface with the mobile device so as to achieve the required control of either of the first and second applications.

In both of the above examples of FIGS. 5 and 6, it should be appreciated that the graphical output from the module 74 can be implemented by any appropriate digital composition of the application output data.

Further, the output from the module 76 can be implemented by setting the output of the preceding module 74 as an overlay on top of a layer allocated for the first application, or can be implemented using alpha-blending operations between the output data associated with the first application and the output data associated with the second application.

In general however, it should be appreciated that any appropriate image processing technique can be employed to generate the output data and examples include

Euclidian Geometry Transformations, such as for example, rotation and enlargement; digital compositing through the combination of two or more images; segmentation so as simplify its representation for analysis purposes and interpolation although this list should not in anyway to be considered exhaustive.

It should be appreciated that the present invention can advantageously provide for two-in-one mobile PC device in which, for example, mobile device applications can be executed locally and PC applications can be executed remotely on a virtualized PC operated by a remote server.

It should further be appreciated that the invention is not restricted to the details of the forgoing embodiment. For example, the system can comprise any appropriate number, and variety of different display-developing devices and, indeed, any appropriate form of interface devices for interfacing both with the user display device driven by the remote server, and the local mobile radio communications device. While examples have been illustrated in which the mobile radio communications device comprises a mobile device, it will be appreciated that any appropriate mobile device exhibiting some form of communication functionality can be employed. In addition it should be appreciated that the invention is not limited to wireless communication system and can also apply to wired communication system (e.g. through an ADSL or optical fiber connection). It should further be appreciated that within the context of the present application reference to communications is intended to broadly encompass the delivery of contents/data/signaling from one device to another, and for purposes for example of control, display or otherwise.

1. A method of displaying to a user at a user display device content delivered from a remote server, and of displaying to the user content from a mobile radio communications device, the method comprising the steps of routing the content from the remote server to the user display device via said mobile radio communications device, and delivering content from the mobile radio communications device to the user display device for display thereon.

2. The method as claimed in claim 1, wherein the step of delivering the content from the mobile radio communications device to the user's display device is a selectively initiated step.

3. The method as claimed in claim 2, wherein said initiation step is responsive to the application within the mobile radio communications device.

4. The method as claimed in claim 3, wherein the delivery of content from the mobile radio communications device is responsive to an incoming signal arriving at the mobile radio communications device and/or the user's response to the arrival of that signal.

5. The method as claimed in claim 1, wherein the display of content delivered from the remote server occurs simultaneously with the display of content from the mobile radio communications device.

6. The method as claimed in claim 5, wherein said simultaneous display arises from the combination of the content from the remote server and the content from the mobile radio communications device locally at the mobile radio communications device.

7. The method as claimed in claim 5, wherein the combination of the content from the remote server device and the content from the mobile radio communications device is completed at the remote server.

8. The method as claimed in claim 1, further including the step of interfacing with the mobile radio communications device by way of user interface means associated with the user display device.

9. The method as claimed in claim 8, wherein control signaling arising from the user interface device associated with the user display device is delivered to the mobile radio communications device.

10. The method as claimed in claim 8, wherein control signaling from the user interface device associated with the user display device can be delivered to the remote server via the mobile radio communications device.

11. The method as claimed in claim 8, wherein at the mobile radio communications device, the control signaling arriving from the user interface device associated with the user display device is selectively employed to interface with the mobile radio communications device and/or the remote server.

12. A mobile radio communications device arranged to display content according to an application therein and to receive content from a remote server and to deliver the content from the remote server to a user display device remote from the radio communications device, and to further deliver the content derived from said application to said user display device for display thereon.

13. The mobile radio communication device as claimed in claim 12, wherein the delivery of content relating to the application on the mobile radio communications device is selective and/or responsive to the application.

14. The mobile radio communications device as claimed in claim 12, and arranged to receive control signaling from a user interface device associated with the user display device and to deliver such control signaling to the remote server and/or to allow for control of said application in accordance with said control signaling.

15. The mobile radio communication device as claimed in claim 12, and arranged such that the control of the application by way of the control signaling is achieved in a selective and/or responsive manner.

16. The mobile radio communications device as claimed in claim 12, further including at least one module for the combination of said content.

17. The mobile radio communications device as claimed in claim 16, further including a first module for rendering mobile application data and mobile communications device emulation data relating to external characteristics of the mobile radio communications device.

18. The mobile radio communications device as claimed in claim 17, further including a second module for combining an output of said first module with rendering data relating to a server-based application from the remote server.

19. A communications system including a user display device, a server remote from the user display device and for delivering content to the user display device, and a mobile radio communications device for access by the user, the system being arranged to route content from the server to the user display device via the mobile radio communications device, and to display content from the mobile radio communications device at the user display device.

20. The communication system as claimed in claim 19, wherein the content is delivered wirelessly to the user display device.

21. A communications system including a user display device, a server remote from the user display device and for delivering content to the user display device, and a mobile radio communications device for access by the user, the system being arranged to route content from the server to the user display device via the mobile radio communications device and to display content from the mobile radio communications device at the user display device, and arranged to operate according to a method as claimed in claim 1.

22. A communications system including a user display device, a server remote from the user display device and for delivering content to the user display device, and a mobile radio communications device for access by the user, the system being arranged to route content from the server to the user display device via the mobile radio communications device, and to display content from the mobile radio communications device at the user display device, further including a mobile radio communications device as defined in claim 12.

23. A method of controlling the display of content relating to an application of a mobile radio communications device and including the step of delivering said content to a remote user display device, which is also arranged for displaying content delivered from a remote server and via the mobile radio communications device.

24. A computer program, computer program product, or computer-readable medium, including instructions for carrying out one or more steps of claim 1.
